(19) United States
(12) Patent Application Publication
(10) Pub. No.: US 2022/0111515 A1
(43) Pub. Date: Apr. 14, 2022

(54) Method and Apparatus for Managing Robot Program

(71) Applicant: ABB Schweiz AG, Baden (CH)

(72) Inventors: Haifei He, Shanghai (CN); Lei Mao, Shanghai (CN); Zhao Jin, Shanghai (CN)

(73) Assignee: ABB Schweiz AG, Baden (CH)

(21) Appl. No.: 17/418,490

(22) PCT Filed: Feb. 13, 2019
(86) PCT No.: PCT/CN2019/075001

§ 371 Date: Jun. 25, 2021

(51) Int. Cl. B25J 9/16

(52) U.S. Cl. CPC B25J 9/163; B25J 9/1671; B25J 9/1664

(57) ABSTRACT

Methods for controlling a robot system. In the method, a robot program for controlling a motion path of the robot system is imported, the motion path is used for processing a first workpiece into a second workpiece, and the robot program includes a variable for representing a parameter for controlling a feature of the motion path. A user of the robot system is provided with an interface for controlling the robot system. The robot program is updated based on an input from the user for adjusting the parameter. Further, embodiments of present disclosure provide corresponding apparatuses, systems and media for controlling a robot system, and methods, apparatuses, systems, and media for generating a robot program. With these embodiments, the robot program may be adjusted at an online side without a need to return to an offline programming tool for updating the robot program.

### FIELD

Example embodiments of the present disclosure generally relate to a robot system, and more specifically, to methods, apparatuses, systems, and computer readable media for managing a robot program.

### BACKGROUND

With the development of computer and automatic control, robot systems have been widely used to process various types of objects in the manufacturing industry. Typically, the robot system may be used to process a workpiece. For example, a first workpiece in a first shape may be processed into a second workpiece in a second shape. A robot program may be generated in advance to control the robot system for the above processing. Then, the robot program may be imported into a controller of the robot system. However, it is difficult to modify the robot program after the robot program is imported into the controller. Therefore, how to managing the robot program in a more effective and convenient manner becomes a focus.

### SUMMARY

Example embodiments of the present disclosure provide solutions for managing a robot program.

In a first aspect, example embodiments of the present disclosure provide a method for controlling a robot system. The method comprises: importing a robot program for controlling a motion path of the robot system, the motion path being used for processing a first workpiece into a second workpiece, and the robot program comprising a variable for representing a parameter for controlling a feature of the motion path; providing a user of the robot system with an interface for controlling the robot system; and in response to receiving an input from the user for adjusting the parameter, updating the robot program based on the input. With these embodiments, the variable in the robot program may represent a parameter for controlling a feature of the motion path. For example, a tool angle for configuring an angle of the tool may be an example of the parameter. At this point, a variable “ANGLE” may be defined in the robot program for allowing the user to adjust the feature of the motion path in an easier and convenient manner. Especially, with the interface, the robot program may be adjusted at a controller of the robot system in an online mode without a need to return back to an offline programming tool.

In some embodiments of the present disclosure, updating the robot program comprises: updating a value of the variable based on the input. In these embodiments, the user may input desired value for adjusting the parameter, and thus the value of the variable in the robot program may be updated based on the user input. For example, the user may input “46°” and modify the value of the variable “ANGLE” to “46°.”

In some embodiments of the present disclosure, the method further comprises: controlling the robot system based on the updated robot program, such that the robot system is to process the first workpiece into the second workpiece based on the updated robot program. With these embodiments, the robot program may be directly updated without a need for rewriting the robot program in a separate offline programming tool.

In some embodiments of the present disclosure, a value of the variable is determined based on a process definition for determining a procedure of the robot system for processing the first workpiece into a second workpiece. Here, the process definition may define a general procedure of the robot system for processing the first workpiece into a second workpiece. Accordingly the value of the variable may be a default value obtained from the process definition. Further, via the variable in the robot program, the user may adjust the default value to any desired value.

In some embodiments of the present disclosure, a position of the variable in the robot program is determined based on a template defining a mapping between the parameter and a value corresponding to the parameter in the robot program. With these embodiments, the template may define a mapping between the parameter and the value, such that these embodiments may provide a flexible manner for defining which value(s) in the robot program may correspond to the parameter and thus may be represented by the variable.

In some embodiments of the present disclosure, the method further comprises: in response to receiving an input from the user for running the robot system, launching the robot program for running the robot system. Sometimes, the user may possibly adjust the robot program, while sometimes the user may directly run the robot system based on the original robot program without any amendment. These embodiments provide an alternative manner for running the robot system directly. Therefore, both of the robot program according to the present disclosure and a traditional robot program may be launched for controlling the robot system.

In some embodiments of the present disclosure, the method is implemented at a robot controller of the robot system. Compared to a traditional solution for rewriting the robot program at the offline programming tool, these embodiments allow the robot program to be updated at the robot controller of the robot system directly. Further, the updated robot program may be used for controlling the robot system.

In some embodiments of the present disclosure, the method further comprises: exporting the updated robot program into a program library. With these embodiments, the updated robot program may be exported into a program library for further use. For example, the program library may be imported into a further robot system to process a first workpiece into a second workpiece. For example, the program library may be imported into the offline programming tool for further modification.

In some embodiments of the present disclosure, the feature of the motion path comprises at least one of: a tool angle for controlling the motion path; a tool width for controlling the motion path; a tool type for controlling the motion path; a process movement for controlling the motion path; and a non-process movement for controlling the motion path. With these embodiments, various features for controlling the motion path may be parameterized in the robot program, therefore the robot program may be easily updated by user input at a controller of the robot system.

In a second aspect, example embodiments of the present disclosure provide an apparatus for controlling a robot system. The apparatus comprises: an importing unit configured to import a robot program for controlling a motion path of the robot system, the motion path being used for processing a first workpiece into a second workpiece, and the robot program comprising a variable for representing a parameter for controlling a feature of the motion path; a providing unit configured to provide a user of the robot system with an interface for controlling the robot system; and an updating unit configured to, in response to receiving an input from the user for adjusting the parameter, update the robot program based on the input.

In some embodiments of the present disclosure, the updating unit comprises: a value updating unit configured to update a value of the variable based on the input.

In some embodiments of the present disclosure, the apparatus further comprises: a controlling unit configured to control the robot system based on the updated robot program, such that the robot system is to process the first workpiece into the second workpiece based on the updated robot program.

In some embodiments of the present disclosure, a value of the variable is determined based on a process definition for determining a procedure of the robot system for processing the first workpiece into a second workpiece.

In some embodiments of the present disclosure, a position of the variable in the robot program is determined based on a template defining a mapping between the parameter and a value corresponding to the parameter in the robot program.

In some embodiments of the present disclosure, the apparatus further comprises: a launching unit configured to, in response to receiving an input from the user for running the robot system, launch the robot program for running the robot system.

In some embodiments of the present disclosure, the apparatus is implemented at a robot controller of the robot system.

In some embodiments of the present disclosure, the apparatus further comprises: an exporting unit configured to export the updated robot program into a program library.

In some embodiments of the present disclosure, the feature of the motion path comprises at least one of: a tool angle for controlling the motion path; a tool width for controlling the motion path; a tool type for controlling the motion path; a process movement for controlling the motion path; and a non-process movement for controlling the motion path.

In a third aspect, example embodiments of the present disclosure provide a system for controlling a robot system. The system comprises: a computer processor coupled to a computer-readable memory unit, the memory unit comprising instructions that when executed by the computer processor implements the method for controlling a robot system according to a first aspect of the present disclosure.

In a fourth aspect, example embodiments of the present disclosure provide a computer readable medium having instructions stored thereon, the instructions, when executed on at least one processor, cause the at least one processor to perform the method for controlling a robot system according to a first aspect of the present disclosure.

In a fifth aspect, example embodiments of the present disclosure provide a method for generating a robot program for controlling a robot system. The method comprises: obtaining a process definition for defining a procedure of the robot system to process a first workpiece into a second workpiece; determining from the obtained process definition a parameter for controlling a feature of a motion path of the robot system, the motion path being used for processing the first workpiece into the second workpiece; and generating a robot program for controlling the motion path based on the obtained process definition and the determined parameter, the robot program comprising a variable for adjusting the parameter. With these embodiments, the variable in the robot program provides more readability to the robot program. Further, the value of the variable may be adjusted for modifying the parameter that controls the feature of the motion path of the robot system. Therefore, it is provided a much easier and convenient manner for modifying the motion path of the robot system without a need to rewrite the robot program in the offline program tool.

In some embodiments of the present disclosure, obtaining the process definition comprises: obtaining a shape model representing dimensions of a shape of the first workpiece; obtaining a description of the second workpiece; and determining the process definition based on the obtained shape model and the description. Here, the shape model may be represented by a Computer Aided Design, CAD) model and the description may be represented by any suitable format for the second workpiece. With these embodiments, the process definition that defines how to process the first workpiece into the second workpiece may be clearly determined.

In some embodiments of the present disclosure, generating the robot program comprises: providing in the robot program the variable for representing a value of the parameter; determining a value of the parameter from the process definition; and setting a value of the variable based on the determined value. It is to be understood that the robot program may comprise multiple lines for describing the motion of the robot system. In a traditional solution for generating the robot program, the lines associated with a feature of the motion path are already interpreted into values in the machine language which is almost unreadable to the user. With these embodiments, the variable provides more readability to the robot program. Further, by setting the value of the variable to a further value, the feature of the motion path may be easily modified.

In some embodiments of the present disclosure, providing in the robot program the variable comprises: replacing at least one value associated with the parameter in the robot program with the variable. With these embodiments, the value(s) associated with the parameter in the robot program may be replaced with the variable. Further, the robot program may be modified by simply setting the variable to a desired value, instead of replacing all the value(s) in the robot program one by one.

In some embodiments of the present disclosure, the method further comprises: determining the at least one value based on a template defining a mapping between the parameter and the at least one value in the robot program. With these embodiments, the template may define a mapping between the parameter and the value, such that these embodiments may provide a flexible manner for defining which value(s) in the robot program may correspond to the parameter and thus may be replaced by the variable.

In some embodiments of the present disclosure, the method is implemented at an offline programming tool for generating a robot program. With these embodiments, the offline programming tool may be modified to increase the readability of the generated robot program.

In some embodiments of the present disclosure, the method further comprises: exporting the generated robot program to a program library for being loaded into a robot controller of the robot system, such that the robot system is to process the first workpiece into the second workpiece. With these embodiments, when the generated robot program is imported into the controller of the robot system, all the lines related to the parameter may be updated by setting the variable to a desired value at the controller. Compared with the traditional solution for modifying the robot program at the offline programming tool to generate an updated robot program and importing the updated robot program again into the robot program, these embodiments may provide an easier and efficient manner for modifying the robot program directly at the controller.

In some embodiments of the present disclosure, the feature of the motion path comprises at least one of: a tool angle for controlling the motion path; a tool width for controlling the motion path; a tool type for controlling the motion path; a process movement for controlling the motion path; and a non-process movement for controlling the motion path. With these embodiments, various features for controlling the motion path may be parameterized in the robot program, therefore, the robot program may be easily updated by user input at a controller of the robot system.

In a sixth aspect, example embodiments of the present disclosure provide an apparatus generating a robot program for controlling a robot system. The apparatus comprises: an obtaining unit configured to obtain a process definition for defining a procedure of the robot system to process a first workpiece into a second workpiece; a determining unit configured to determine from the obtained process definition a parameter for controlling a feature of a motion path of the robot system, the motion path being used for processing the first workpiece into the second workpiece; and a generating unit configured to generate a robot program for controlling the motion path based on the obtained process definition and the determined parameter, the robot program comprising a variable for adjusting the parameter.

In some embodiments of the present disclosure, the obtaining unit comprises: a shape obtaining unit configured to obtain a shape model representing dimensions of a shape of the first workpiece; a description obtaining unit configured to obtain a description of the second workpiece; and a process determining unit configured to determine the process definition based on the obtained shape model and the description.

In some embodiments of the present disclosure, the generating unit comprises: a providing unit configured to providing in the robot program the variable for representing a value of the parameter; a parameter determining unit configured to determine a value of the parameter from the process definition; and a setting unit configured to set a value of the variable based on the determined value.

In some embodiments of the present disclosure, the providing unit comprises: a replacing unit configured to replace at least one value associated with the parameter in the robot program with the variable.

In some embodiments of the present disclosure, the apparatus further comprising: a position determining unit configured to determine the at least one value based on a template defining a mapping between the parameter and the at least one value in the robot program.

In some embodiments of the present disclosure, the apparatus is implemented at an offline programming tool for generating a robot program.

In some embodiments of the present disclosure, the apparatus further comprises: an exporting unit configured to export the generated robot program to a program library for being loaded into a robot controller of the robot system, such that the robot system is to process the first workpiece into the second workpiece.

In some embodiments of the present disclosure, the feature of the motion path comprises at least one of: a tool angle for controlling the motion path; a tool width for controlling the motion path; a tool type for controlling the motion path; a process movement for controlling the motion path; and a non-process movement for controlling the motion path.

In a seventh aspect, example embodiments of the present disclosure provide a system for generating a robot program for controlling a robot system. The system comprises: a computer processor coupled to a computer-readable memory unit, the memory unit comprising instructions that when executed by the computer processor implements the method for generating a robot program for controlling a robot system according to a fifth aspect of the present disclosure.

In an eighth aspect, example embodiments of the present disclosure provide a computer readable medium having instructions stored thereon, the instructions, when executed on at least one processor, cause the at least one processor to perform the method for generating a robot program for controlling a robot system according to a fifth aspect of the present disclosure.

In a ninth aspect, example embodiments of the present disclosure provide a robot controlling system. The robot controlling system comprises: an apparatus for generating a robot program for controlling a robot system according to the sixth aspect of the present disclosure; the robot system; and an apparatus for controlling the robot system according to the second aspect of the present disclosure.

### DESCRIPTION OF DRAWINGS

FIG. 1 illustrates a schematic diagram for generating a robot program and controlling a robot system based on the generated robot program in accordance with an solution;

FIG. 2 illustrates a schematic diagram of generating a parameterized robot program and controlling a robot system based on the parameterized robot program in accordance with embodiments of the present disclosure;

FIG. 3 illustrates a schematic diagram of a comparison between a robot program and a parameterized robot program in accordance with embodiments of the present disclosure;

FIG. 4 illustrates a flowchart of a method for generating a robot program in accordance with embodiments of the present disclosure;

FIG. 5 illustrates a schematic diagram of a method for controlling a robot system based on a parameterized robot program in accordance with embodiments of the present disclosure;

FIG. 6 illustrates a schematic diagram of an interface for controlling a robot system in accordance with embodiments of the present disclosure;

FIG. 7A illustrates a schematic diagram of an apparatus for generating a robot program in accordance with embodiments of the present disclosure;

FIG. 7B illustrates a schematic diagram of an apparatus for controlling a robot system in accordance with embodiments of the present disclosure; and

FIG. 8 illustrates a schematic diagram of a system for generating a robot program/controlling a robot system in accordance with embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

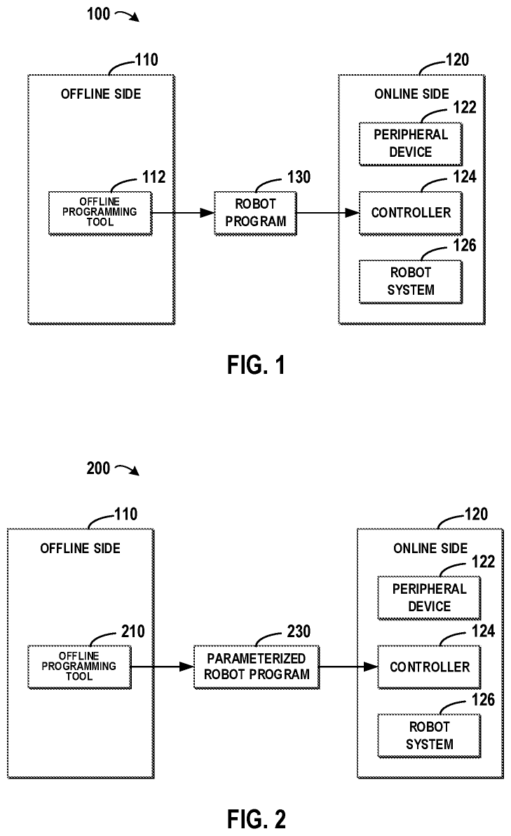

For the sake of description, reference will be made to FIG. 1 to provide a general description of environment of a robot system. FIG. 1 illustrates a schematic diagram 100 of generating a robot program 130 and controlling a robot system 126 based on the generated robot program 130 in accordance with a solution. As shown in FIG. 1, at an offline side 110 there may be an offline programming tool 112 for generating the robot program 130. Here, the robot program 130 may be in a machine language format readable to the controller 124 an online side 120. The online side 120 may comprise the controller 124 for controlling the robot system 126 according to the robot program 130. There may be a peripheral device 122 such as a touch sensitive device for operating the controller 124.

In the solution as shown in FIG. 1, after the robot program 130 is imported into the controller 124, the robot system 126 may be driven by the robot program 130. However, sometimes, the robot program 130 needs to be modified after being imported. For example, the robot program 130 may define a motion path of the robot system 126 to process a first workpiece into a second workpiece, where the tool angle is set to an angle of 45°. However, if the user wants to modify the tool angle to an angle of 46°, the user has to return to the offline programming tool 112 to modify the angle and generate an updated program. Further, the updated program may be imported into the controller 124 for controlling the robot system 126. The above procedure for modifying the robot program 130 involves multiple steps at both the offline side 110 and the online side 120, which may result in a lot of manpower and time overhead.

In order to at least partially solve the above and other potential problems, a new method for generating a robot program is disclosed according to embodiments of the present disclosure. In general, according to embodiments of the present disclosure, a parameterized robot program comprising a parameter may be generated by the offline programming tool according to embodiments. The parameterized robot program may be used for controlling the motion path of the robot system to process the first workpiece into the second workpiece. Here, the parameter may be used for controlling a feature of a motion path of the robot system.

Reference will be made to FIG. 2 for more details about the present disclosure. FIG. 2 illustrates a schematic diagram 200 of generating a parameterized robot program 230 and controlling the robot system 126 based on the parameterized robot program 230 in accordance with embodiments of the present disclosure. Here, the parameter may provide an effective and convenient manner for controlling a feature of a motion path of the robot system. With these embodiments, the variable in the parameterized robot program 230 allows to provide more readability to the robot program. Further, the value of the variable may be adjusted for modifying the parameter that controls the feature of the motion path of the robot system 126. Therefore, it is provided a much easier and convenient manner for modifying the motion path of the robot system 126 without a need to rewrite the robot program in the offline program tool.

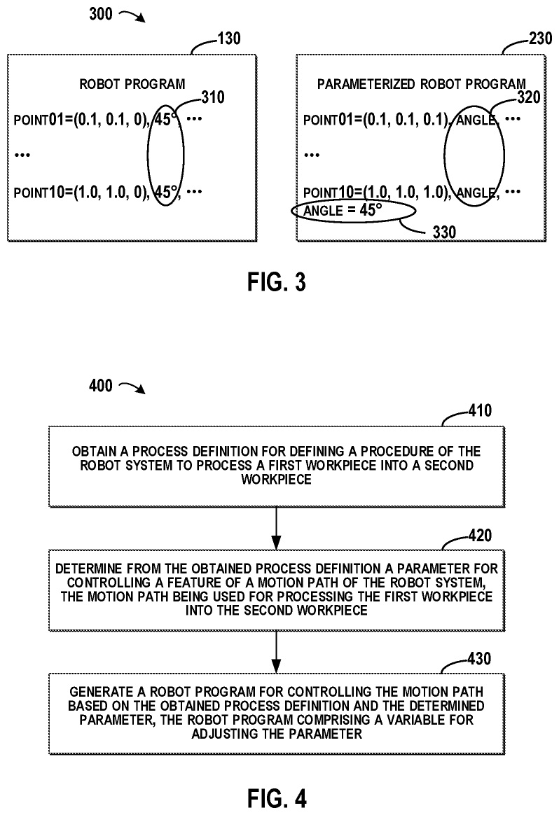

Reference will be made to FIG. 3 for describing the difference between the traditional robot program 130 and the parameterized robot program 230. FIG. 3 illustrates a schematic diagram 300 of a comparison between the robot program 130 and the parameterized robot program 230 in accordance with embodiments of the present disclosure. For the sake of description, embodiments of the present disclosure will be described by taking a simple process as an example. The process relates to drawing a polyline comprising ten points on a surface of the first workpiece by a tool controlled by the robot system 126, and an angle of the tool is set to 45°.

Referring to FIG. 3, the robot program 130 may comprise multiple lines, where the tool angle “45°” is directly written in the robot program 130. When the user of the robot system 126 wants to modify the tool angle to “46°,” the user needs to modify all the values in each line from “45°” to “46°.” The robot program 130 only shows a simple example, while a real robot program may comprises tens of thousands lines, at this time the robot program 130 cannot be modified at the online side 120. Therefore, the robot program 130 should be imported into the offline programming tool 110 for modification.

FIG. 3 shows the parameterized robot program 230 according to embodiments of the present disclosure. As shown in the parameterized robot program 230, the tool angle “45°” is replaced by a variable 320 “ANGLE.” Further, the last line 330 shows that the tool angle is set to “45°.” With these embodiments, the parameterized robot program 230 may be more readable for the user. At the same point, as the controller 124 supports the statement of “ANGLE=45°” for setting a value of the variable “ANGLE,” the parameterized robot program 230 may be run to control the robot system 230. After the parameterized robot program 230 is imported into the controller 124, the parameterized robot program 230 may be directly run. Alternatively, if the user wants to change the tool angle to “46°”, he/she may simply modify the line 330 to “ANGLE=46°.”

The embodiments of the present disclosure relates to two aspects: the offline side 110 and the online side 120. Details of offline side 110 will be provided with reference to FIG. 4, which illustrates a flowchart of a method 400 for generating a robot program in accordance with embodiments of the present disclosure. At block of 410, a process definition may be obtained, and the process definition may define a procedure of the robot system for processing the first workpiece into the second workpiece. The process definition may be in any suitable format as long as it may define how to process the first workpiece into the second workpiece.

In some embodiments of the present disclosure, a shape model may be obtained. The shape model may represent dimensions of a shape of the first workpiece. For example, the shape model may be represented by a Computer Aided Design, CAD) model. Alternatively, the shape model may be represented by another 3D model that defines dimensions of the first workpiece. Then, a description of the second workpiece may be obtained. Here, the description may be represented by various formats such as a sequence of actions to be performed by the robot system 126.

Continuing the above example for drawing a polyline through a group of points, the description may involve the x, y and z coordinates for the group of points, and a tool angle. It is to be understood that the above example is an example description and a real description may relates to more aspects for defining the second workpiece. Further, the process definition may be determined based on the shape model and the description. With these embodiments, the process definition that defines how to process the first workpiece into the second workpiece may be determined in an effective and convenient manner. In some embodiments, the process definition may be stored in an example data structure as shown in Table 1. In other embodiments, the process definition may be saved in another data structure with different columns in the table.

TABLE 1
Example data structure of process definition

| No. | Feature | Value |
|---|---|---|
| 1 | path | point01(0.1, 0.1, 0), . . . , point10(1.0, 1.0, 0) |
| 2 | tool angle | 45° |
| . . . | . . . | . . . |

At block of 420, a parameter for controlling a feature of a motion path of the robot system may be determined from the obtained process definition. In order to processing the first workpiece into the second, multiple features may be used to define the motion path. In some embodiments, the tool angle may be an example feature for the motion path. In other embodiments, the feature of the motion path may comprise at least one of: a tool angle for controlling the motion path; a tool width for controlling the motion path; a tool type for controlling the motion path; a process movement for controlling the motion path; and a non-process movement for controlling the motion path. With these embodiments, various features for controlling the motion path may be parameterized in the robot program, therefore, the robot program may be easily updated by user input at a controller of the robot system. In these embodiments, a tool angle may be used to define an angle of the tool during the processing. Although the disclosure uses a variable to represent the angle, in a real robot system, the angle may be defined in form of a triple (yaw, pitch, roll). Alternatively, the angle may also be defined in form of a tetrad (w, x, y, z). The tool width may represent the width of the processing tool, such as, 5 mm, or another value. The tool type may represent the type of the tool that may be used by the robot system. The process movement may represent a path of the robot system when the tool is in touch with the first workpiece. The non-process movement may represent a path of the robot system when the tool is not touch with the first workpiece. It is to be understood that the paragraph only provides example features of the motion path. In other embodiments, more or less features may be involved for determining the motion path.

At block of 430, the parameterized robot program 230 comprising a variable for adjusting the parameter may be generated based on the obtained process definition and the determined parameter, and the parameterized robot program may be used for controlling the motion path of the robot system for processing the first workpiece into the second workpiece. Referring back to FIG. 3, the variable 320 “ANGLE” may be used to adjust the tool angle during processing the first workpiece into the second workpiece.

In some embodiments of the present disclosure, the variable 320 may be provided in the parameterized robot program 230 for representing a value of the parameter. Then, a value of the parameter may be obtained from the process definition. Continuing the above example process definition as shown in Table 1, the value “45°” associated with the feature of “tool angle” may be used as the value of the parameter. Then, the line 330 may be added into the parameterized robot program 230 for setting a value of the variable 320 based on the determined value “45°.” Based on the line 330, the variable 320 may be set to the value of “45°,” such that when the parameterized robot program 230 is run at the controller 124, the robot system 126 may process the first workpiece by setting the tool angle to “45°.” Further, the variable 320 allow the user of the robot system 126 to adjust the value to another desired value.

In a traditional solution for generating the robot program, in the robot program, the lines associated with a feature of the motion path are already interpreted into values in the machine language format which is almost unreadable to the user. However, with the parameterized robot program 230, the line 330 may be easily modified at the online side 120 when the parameterized robot program 230 is imported into the controller 124. For example, the user of the robot system 126 may modify the line 330 to “ANGLE=46°.” With these embodiments, the robot program 230 may be directed modified at the online side 120 without a need to go back to the offline programming tool 110. With these embodiments, the variable provides more readability to the parameterized robot program 230. Further, by setting the value of the variable 320 to a further value, the feature of the motion path may be easily modified.

In some embodiments of the present disclosure, if the robot program 130 generated based on a traditional solution is obtained, then at least one value (such as the values 310 shown in FIG. 3) in the robot program 130 may be found and replaced with the variable 320 so as to generate the parameterized robot program 230 according to the present disclosure. Here, the value(s) associated with the parameter in the robot program 130 may be replaced with the variable for generating the parameterized robot program 230. Further, the parameterized robot program 230 may be modified by simply setting the variable to a desired value, instead of replacing all the value(s) one by one.

In some embodiments of the present disclosure, the value(s) 310 that is to be replaced by the variable 320 may be determined from a template defining a mapping between the parameter and the at least one value in the robot program 130. Table 2 shows an example template for defining a mapping between the tool angle and the value(s) 310.

TABLE 2
Example Template

<ExportRule>

<_behavior>TARGETDEF</_behavior>
<_name>Target</_name>
<_instructions>

<ExportInstruction>

<_name />
<_Instruction>CONST

robtarget %Target_name:=[[%Target_x, %Target_y, %Target_z],[%ANGLE], ...];</_Instruction>

<_paras>

<InstructionPara>

<_keyWord />
<_behavior />
<_paraStr>%Target_name</_paraStr>

</InstructionPara>

...

</_paras>
<_udeparas/>

</ExportInstruction>

</_instructions>
<_UDEinstructions />

</ExportRule>

As shown in Table 2, the line “<_Instruction> CONST robtarget % Target_name:=[[% Target_x, % Target_y, % Target_z], [% ANGLE], . . . ]; </_Instruction>” defines the mapping. With this template, lines with a similar format of “point01=(0.1, 0.1, 0), 45°, . . . ” may be identified from the robot program 130 and then “45°” may be replaced by the variable 320. With respect to the robot program 130 in FIG. 3, the lines related to “point01, . . . , point10” may be identified and then the value 310 may be replaced by “ANGLE.”

It is to be understood that the above just shows an example where the tool angle is defined by one variable. The angle may be defined in other forms such as a triple (yaw, pitch, roll) or a tetrad (w, x, y, z). At this point, the template may be modified to adapt to the triple/tetrad. For example, the template for a tool angle defined with a tetrad (w, x, y, z) is provided in Table 3 as below. In Table 3, “Target_q1” to “Target_q4” correspond to the four members in the tetrad (w, x, y, z). With these embodiments, the template may define a mapping between the parameter and the value, such that these embodiments may provide flexible manners for defining which value(s) in the robot program may correspond to the parameter and thus may be replaced by the variable.

TABLE 3
Example Template

<ExportRule>

<_behavior>TARGETDEF</_behavior>
<_name>Target</_name>
<_instructions>

<ExportInstruction>

<_name />
<_Instruction>CONST

robtarget %Target_name:=[[%Target_x, %Target_y, %Target_z],[%Target_q1, %Target_q2, %Target_q
3, %Target_q4],...];</_Instruction>

<_paras>

<InstructionPara>

<_keyWord />
<_behavior />
<_paraStr>%Target_name</_paraStr>

</InstructionPara>

...

</_paras>
<_udeparas/>

</ExportInstruction>

</_instructions>
<_UDEinstructions />

</ExportRule>

In some embodiments of the present disclosure, the method may be implemented at the offline programming tool 210 for generating a robot program. With these embodiments, the offline programming tool 210 may be improved to increase the readability of the generated robot program. The offline side 110 and the online side 120 may communicate via the parameterized robot program 230.

In some embodiments of the present disclosure, the parameterized robot program 230 may be exported to a program library for being loaded into a robot controller of the robot system, such that the first workpiece is to be processed into the second workpiece by the robot system 126 based on the parameterized robot program 230. With these embodiments, when the parameterized robot program 230 is imported into the controller 124, both of the parameter and the value of the variable corresponding to the parameter may be provided to the user of the robot system 126, such that the user may modify the value to a desired value. Compared with the traditional solution for modifying the robot program at the offline programming tool 210 to generate an updated robot program and importing the updated robot program again into the robot system 126, these embodiments may provide an easier and efficient manner for modifying the robot program directly at the robot controller 124.

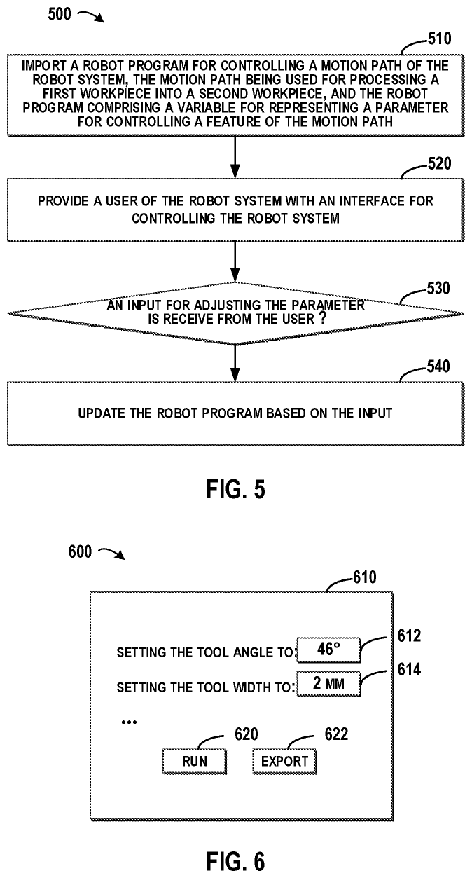

The operations at the online side 120 relates to implementations after the parameterized robot program 230 is imported into the controller, and details will be provided with reference to FIG. 5. FIG. 5 illustrates a schematic diagram of a method 500 for controlling the robot system 126 based on the parameterized robot program 230 in accordance with embodiments of the present disclosure. At block of 510, the parameterized robot program 230 for controlling a motion path of the robot system 126 may be imported into the controller 124. Here, the motion path may be used for processing the first workpiece into the second workpiece, and the parameterized robot program 230 may comprise a variable for representing a parameter for controlling a feature of the motion path.

Referring back to FIG. 3, the parameterized robot program 230 comprising the variable 320 may be imported into the controller 124, here the variable 320 may represent a parameter for controlling the tool angle of the motion path. With these embodiments, the variable 320 may provide more readability to the parameterized robot program 230, so as to provide an editable manner for the variable 320 at the online side 120.

In some embodiments of the present disclosure, the feature of the motion path may comprise at least one of: a tool angle for controlling the motion path; a tool width for controlling the motion path; a tool type for controlling the motion path; a process movement for controlling the motion path; and a non-process movement for controlling the motion path. With these embodiments, various features for controlling the motion path may be parameterized in the robot program, therefore the robot program may be easily updated by user input at a controller of the robot system. Details about various features of the motion path are similar as those described for the offline side 110 in proceeding paragraphs, and details may be omitted hereinafter.

At block of 520, a user of the robot system 126 may be provided with an interface for controlling the robot system 126. Reference will be made to FIG. 6 for details, which figure illustrates a schematic diagram of an interface 600 for controlling the robot system 126 in accordance with embodiments of the present disclosure. As shown in FIG. 6, a dialog 610 of the interface 600 may be displayed to the user. Based on the variable 320 comprised in the parameterized robot program 230, one or more editable boxes (or other components) for setting the value of the variable 320 may be displayed. In FIG. 6, an editable box 612 is displayed for adjusting the value of the tool angle, and an editable box 614 is displayed for adjusting the value of the tool width.

At block of 530, if an input is received from the user for adjusting the parameter, the parameterized robot program 230 may be updated based on the input. With the interface 600, the user may adjust the value of the variable 320 so as to control the corresponding feature of the motion path. For example, the user may set the value of the variable “ANGLE” to “46°.” With these embodiments, the variable in the robot program may represent a parameter for controlling a feature of the motion path. At this point, the variable(s) in the imported program may allow the user to adjust the feature of the motion path in an easier and convenient manner.

In some embodiments of the present disclosure, updating the robot program comprises: updating a value of the variable based on the input. In these embodiments, the user may input desired value for adjusting the parameter, and thus the value of the variable in the robot program may be updated based on the user input. For example, the user may input “46°” degree to update the value of the variable “ANGLE” to “46°.”

Although the above paragraphs provide an example for replacing all the “45°” in the robot 130 with the variable “ANGLE,” the template may define a complicated mapping between the parameter and one or more values associated with the parameter. In this way, the template may define how to translate the motion path logic into the parameterized robot program 230.

Hereinafter, an example related to updating more values based on the template will be provided. For example, the parameterized robot program 230 defines a process to draw a square with a side length of 10 mm on the surface of the first workpiece with a tool width of 1 mm. As the positions of the four vertexes of the square are associated with the tool width, the positions may change along with a change in the tool width according to a predefined template based on the tool width and the side length.

Supposing the first vertex locates at (0, 0, 0), and the other three vertexes may locate at (11, 0, 0), (11, 11, 0) and (0, 11, 0), which are determined based on a template including the side length and tool width:

a position of the second vertex=(0, side length+tool width, 0, 0);

a position of the third vertex=(0, side length+tool width, side length+tool width, 0); and

a position of the fourth vertex=(0, 0, side length+tool width, 0).

The template may define that values related to both positions of the three vertexes and the tool width should be updated if the tool width changes. With these embodiments, if the user modifies the tool width from “1 mm” to “2 mm” at the online side 120, the positions of the three vertexes in the parameterized robot program 230 should be updated to (12, 0, 0), (12, 12, 0) and (0, 12, 0), and the tool width should be updated to 2 according to the above template. Based on the above principle, engineers may adopt other templates for defining other aspects in generating the robot program according to their specific requirements.

In some embodiments of the present disclosure, the method further comprises: controlling the robot system based on the updated robot program, such that the robot system is to process the first workpiece into the second workpiece based on the updated robot program. With these embodiments, the robot program may be directly updated without a need for rewriting the robot program in a separate offline programming tool.

Sometimes, the user may possibly adjust the robot program, while sometimes the user may directly run the robot system based on the original robot program without any amendment. In some embodiments of the present disclosure, the imported program may be run directly at the controller 126. The user may run the imported program by click a button 620 in the interface 600. At this point, an input for running the robot system 126 is received from the user, and then the imported program may be directly run to control the robot system 126. These embodiments provide an alternative manner for running the robot system directly. Therefore, both of the robot program according to the present disclosure and a traditional robot program may be launched in the robot system.

In some embodiments of the present disclosure, the method is implemented at a robot controller of the robot system. Compared to a traditional solution for rewriting the robot program at the offline programming tool 210, these embodiments allow the robot program to be updated at the robot controller 124 of the robot system 126 directly. Further, the updated robot program may be used for controlling the robot system 126.

In some embodiments of the present disclosure, the updated robot program may be exported into a program library. With these embodiments, the updated robot program may be saved into a program library for further use, and various versions of the robot program may be saved. For example, if the user wants to process two batches of the first workpiece by setting the tool angles to “45°” and “46°,” then two versions may be saved into two program libraries. Further, the program library may be imported into a further robot system to process a first workpiece into a second workpiece. For example, the program library may be imported into the offline programming tool for further modification.

In some embodiments of the present disclosure, a value of the variable is determined based on a process definition for determining a procedure of the robot system 126 for processing the first workpiece into a second workpiece. Here, the process definition may define a general procedure of the robot system 126 during processing the first workpiece into a second workpiece. Accordingly the value of the variable may be a default value obtained from the process definition. Further, via the variable in the robot program, the user may adjust the default value to any desired values. Details about determination of value is similar as those described for the offline side 110 in proceeding paragraphs, and details may be omitted hereinafter.

In some embodiments of the present disclosure, a position of the variable in the robot program is determined based on a template defining a mapping between the parameter and a value corresponding to the parameter in the robot program. With these embodiments, the template may define a mapping between the parameter and the value, such that these embodiments may provide flexible manners for defining which value(s) in the robot program may correspond to the parameter and thus may be represented by the variable. Details about the template is similar as those described for the offline side 110 in proceeding paragraphs, and details may be omitted hereinafter.

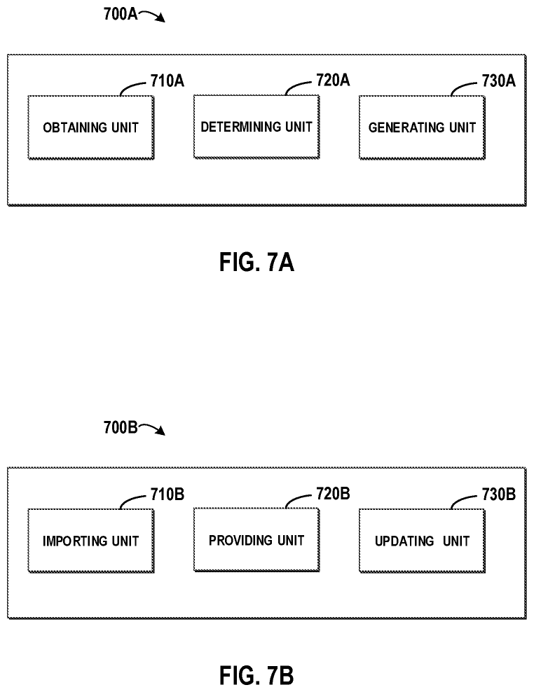

In some embodiments of the present disclosure, an apparatus for generating a robot program for controlling a robot system is provided. FIG. 7A illustrates a schematic diagram of an apparatus 700A for generating a robot program for controlling a robot system in accordance with embodiments of the present disclosure. As illustrated in FIG. 7A, the apparatus 700A may comprise: an obtaining unit 710A configured to obtain a process definition for defining a procedure of the robot system to process a first workpiece into a second workpiece; a determining unit 720A configured to determine from the obtained process definition a parameter for controlling a feature of a motion path of the robot system, the motion path being used for processing the first workpiece into the second workpiece; and a generating unit 730A configured to generate a robot program for controlling the motion path based on the obtained process definition and the determined parameter, the robot program comprising a variable for adjusting the parameter.

In some embodiments of the present disclosure, the obtaining unit 710A comprises: a shape obtaining unit configured to obtain a shape model representing dimensions of a shape of the first workpiece; a description obtaining unit configured to obtain a description of the second workpiece; and a process determining unit configured to determine the process definition based on the obtained shape model and the description.

In some embodiments of the present disclosure, the generating unit 730A comprises: a providing unit configured to providing in the robot program the variable for representing a value of the parameter; a parameter determining unit configured to determine a value of the parameter from the process definition; and a setting unit configured to set a value of the variable based on the determined value.

In some embodiments of the present disclosure, the providing unit comprises: a replacing unit configured to replace at least one value associated with the parameter in the robot program with the variable.

In some embodiments of the present disclosure, the apparatus 700A further comprises: a position determining unit configured to determine the at least one value based on a template defining a mapping between the parameter and the at least one value in the robot program.

In some embodiments of the present disclosure, the apparatus 700A is implemented at an offline programming tool for generating a robot program.

In some embodiments of the present disclosure, the apparatus 700A further comprises: an exporting unit configured to export the generated robot program to a program library for being loaded into a robot controller of the robot system, such that the robot system is to process the first workpiece into the second workpiece.

In some embodiments of the present disclosure, the feature of the motion path comprises at least one of: a tool angle for controlling the motion path; a tool width for controlling the motion path; a tool type for controlling the motion path; a process movement for controlling the motion path; and a non-process movement for controlling the motion path.

In some embodiments of the present disclosure, an apparatus for controlling the robot system 126 is provided. FIG. 7B illustrates a schematic diagram of an apparatus 700B for controlling the robot system in accordance with embodiments of the present disclosure. As illustrated in FIG. 7B, the apparatus 700B may comprise: an importing unit 710B configured to import a robot program for controlling a motion path of the robot system, the motion path being used for processing a first workpiece into a second workpiece, and the robot program comprising a variable for representing a parameter for controlling a feature of the motion path; a providing unit 720B configured to provide a user of the robot system with an interface for controlling the robot system; and an updating unit 730B configured to, in response to receiving an input from the user for adjusting the parameter, update the robot program based on the input.

In some embodiments of the present disclosure, the updating unit 730B comprises: a value updating unit configured to update a value of the variable based on the input.

In some embodiments of the present disclosure, the apparatus 700B further comprises: a controlling unit configured to control the robot system based on the updated robot program, such that the robot system is to process the first workpiece into the second workpiece based on the updated robot program.

In some embodiments of the present disclosure, a value of the variable is determined based on a process definition for determining a procedure of the robot system for processing the first workpiece into a second workpiece.

In some embodiments of the present disclosure, a position of the variable in the robot program is determined based on a template defining a mapping between the parameter and a value corresponding to the parameter in the robot program.

In some embodiments of the present disclosure, the apparatus 700B further comprises: a launching unit configured to, in response to receiving an input from the user for running the robot system, launch the robot program for running the robot system.

In some embodiments of the present disclosure, the apparatus 700B is implemented at a robot controller of the robot system.

In some embodiments of the present disclosure, the apparatus 700B further comprises: an exporting unit configured to export the updated robot program into a program library.

In some embodiments of the present disclosure, the feature of the motion path comprises at least one of: a tool angle for controlling the motion path; a tool width for controlling the motion path; a tool type for controlling the motion path; a process movement for controlling the motion path; and a non-process movement for controlling the motion path.

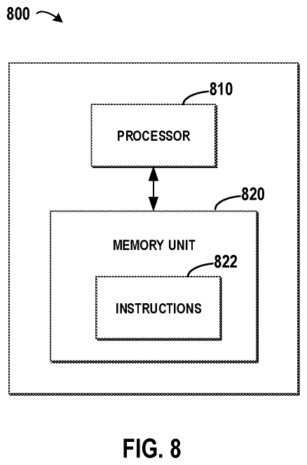

In some embodiments of the present disclosure, a system 800 for generating a robot program is provided. FIG. 8 illustrates a schematic diagram of the system 900 for generating a robot program in accordance with embodiments of the present disclosure. As illustrated in FIG. 8, the system 800 may comprise a computer processor 810 coupled to a computer-readable memory unit 820, and the memory unit 820 comprises instructions 822. When executed by the computer processor 810, the instructions 822 may implement the method 400 for generating a robot program as described in the preceding paragraphs, and details will be omitted hereinafter.

Further, the system 800 may also be used for controlling a robot system in accordance with embodiments of the present disclosure. At this point, when executed by the computer processor 810, the instructions 822 may implement the method 500 for controlling a robot system as described in the preceding paragraphs, and details will be omitted hereinafter.

In some embodiments of the present disclosure, a computer readable medium for generating a robot program is provided. The computer readable medium has instructions stored thereon, and the instructions, when executed on at least one processor, may cause at least one processor to perform the method for generating a robot program as described in the preceding paragraphs, and details will be omitted hereinafter.

In some embodiments of the present disclosure, a computer readable medium for controlling a robot system is provided. The computer readable medium has instructions stored thereon, and the instructions, when executed on at least one processor, may cause at least one processor to perform the method for controlling a robot system as described in the preceding paragraphs, and details will be omitted hereinafter.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 4 and 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for controlling a robot system, comprising:
importing a robot program for controlling a motion path of the robot system, the motion path being used for processing a first workpiece into a second workpiece, and the robot program comprising a variable for representing a parameter for controlling a feature of the motion path;
providing an interface for controlling the robot system; and
in response to receiving an input from the interface for adjusting the parameter, updating the robot program based on the input.

2. The method of claim 1, wherein updating the robot program comprises: updating a value of the variable based on the input.

3. The method of claim 1, further comprising: controlling the robot system based on the updated robot program, such that the robot system is to process the first workpiece into the second workpiece based on the updated robot program.

4. The method of claim 1, wherein a value of the variable is determined based on a process definition for determining a procedure of the robot system for processing the first workpiece into a second workpiece.

5. The method of claim 4, wherein a position of the variable in the robot program is determined based on a template defining a mapping between the parameter and a value corresponding to the parameter in the robot program.

6. The method of claim 1, further comprising:
in response to receiving an input for running the robot system, launching the robot program for running the robot system.

7. The method of claim 1, wherein the method is implemented at a robot controller of the robot system.

8. The method of claim 7, further comprising: exporting the updated robot program into a program library.

9. The method of claim 1, wherein the feature of the motion path comprises at least one of:
a tool angle for controlling the motion path;
a tool width for controlling the motion path;
a tool type for controlling the motion path;
a process movement for controlling the motion path; or
a non-process movement for controlling the motion path.

10. An apparatus for controlling a robot system, comprising:
an importing unit configured to import a robot program for controlling a motion path of the robot system, the motion path being used for processing a first workpiece into a second workpiece, and the robot program comprising a variable for representing a parameter for controlling a feature of the motion path;
a providing unit configured to provide an interface for controlling the robot system; and
an updating unit configured to, in response to receiving an input from the interface for adjusting the parameter, update the robot program based on the input.

11. The apparatus of claim 10, wherein the updating unit comprises: a value updating unit configured to update a value of the variable based on the input.

12. The apparatus of claim 10, further comprising:
a controlling unit configured to control the robot system based on the updated robot program, such that the robot system is to process the first workpiece into the second workpiece based on the updated robot program.

13. The apparatus of claim 10, wherein a value of the variable is determined based on a process definition for determining a procedure of the robot system for processing the first workpiece into a second workpiece.

14. The apparatus of claim 13, wherein a position of the variable in the robot program is determined based on a template defining a mapping between the parameter and a value corresponding to the parameter in the robot program.

15. The apparatus of claim 10, further comprising:
a launching unit configured to, in response to receiving an input for running the robot system, launch the robot program for running the robot system.

16. The apparatus of claim 10, wherein the apparatus is implemented at a robot controller of the robot system.

17. The apparatus of claim 16, further comprising:
an exporting unit configured to export the updated robot program into a program library.

18. The apparatus of claim 10, wherein the feature of the motion path comprises at least one of:
a tool angle for controlling the motion path;
a tool width for controlling the motion path;
a tool type for controlling the motion path;
a process movement for controlling the motion path; or
a non-process movement for controlling the motion path.

19. A system for controlling a robot system, comprising: a computer processor coupled to a computer-readable memory unit, the memory unit comprising instructions that when executed by the computer processor implements the method of claim 1.

20. A computer readable medium having instructions stored thereon, the instructions, when executed on at least one processor, cause the at least one processor to perform the method of claim 1.

21. A method for generating a robot program for generating a robot program, comprising:
obtaining a process definition for defining a procedure of the robot system to process a first workpiece into a second workpiece;
determining from the obtained process definition a parameter for controlling a feature of a motion path of the robot system, the motion path being used for processing the first workpiece into the second workpiece; and
generating a robot program for controlling the motion path based on the obtained process definition and the determined parameter, the robot program comprising a variable for adjusting the parameter.

22. The method of claim 21, wherein obtaining the process definition comprises:
obtaining a shape model representing dimensions of a shape of the first workpiece;
obtaining a description of the second workpiece; and
determining the process definition based on the obtained shape model and the description.

23. The method of claim 21, wherein generating the robot program comprises:
providing in the robot program the variable for representing a value of the parameter;
determining a value of the parameter from the process definition; and
setting a value of the variable based on the determined value.

24. The method of claim 23, wherein providing in the robot program the variable comprises:
replacing at least one value associated with the parameter in the robot program with the variable.

25. The method of claim 24, further comprising:
determining the at least one value based on a template defining a mapping between the parameter and the at least one value in the robot program.

26. The method of claim 21, wherein the method is implemented at an offline programming tool for generating a robot program.

27. The method of claim 21, further comprising: exporting the generated robot program to a program library for being loaded into a robot controller of the robot system, such that the robot system is to process the first workpiece into the second workpiece.

28. The method of claim 21, wherein the feature of the motion path comprises at least one of:
a tool angle for controlling the motion path;
a tool width for controlling the motion path;
a tool type for controlling the motion path;
a process movement for controlling the motion path; or
a non-process movement for controlling the motion path.

29. An apparatus for generating a robot program for controlling a robot system, comprising:
an obtaining unit configured to obtain a process definition for defining a procedure of the robot system to process a first workpiece into a second workpiece;
a determining unit configured to determine from the obtained process definition a parameter for controlling a feature of a motion path of the robot system, the motion path being used for processing the first workpiece into the second workpiece; and
a generating unit configured to generate a robot program for controlling the motion path based on the obtained process definition and the determined parameter, the robot program comprising a variable for adjusting the parameter.

30. The apparatus of claim 29, wherein the obtaining unit comprises:
a shape obtaining unit configured to obtain a shape model representing dimensions of a shape of the first workpiece;
a description obtaining unit configured to obtain a description of the second workpiece; and
a process determining unit configured to determine the process definition based on the obtained shape model and the description.

31. The apparatus of claim 29, wherein the generating unit comprises:
a providing unit configured to providing in the robot program the variable for representing a value of the parameter;
a parameter determining unit configured to determine a value of the parameter from the process definition; and
a setting unit configured to set a value of the variable based on the determined value.

32. The apparatus of claim 31, wherein the providing unit comprises:
a replacing unit configured to replace at least one value associated with the parameter in the robot program with the variable.

33. The apparatus of claim 32, further comprising:
a position determining unit configured to determine the at least one value based on a template defining a mapping between the parameter and the at least one value in the robot program.

34. The apparatus of claim 29, wherein the apparatus is implemented at an offline programming tool for generating a robot program.

35. The apparatus of claim 29, further comprising:
an exporting unit configured to export the generated robot program to a program library for being loaded into a robot controller of the robot system, such that the robot system is to process the first workpiece into the second workpiece.

36. The apparatus of claim 29, wherein the feature of the motion path comprises at least one of:
a tool angle for controlling the motion path;
a tool width for controlling the motion path;
a tool type for controlling the motion path;
a process movement for controlling the motion path; or
a non-process movement for controlling the motion path.

37. A system for generating a robot program for generating a robot program, comprising: a computer processor coupled to a computer-readable memory unit, the memory unit comprising instructions that when executed by the computer processor implements the method of claim 21.

38. A computer readable medium having instructions stored thereon, the instructions, when executed on at least one processor, cause the at least one processor to perform the method of claim 21.

39. An robot controlling system, comprising:
an apparatus for generating a robot program for controlling a robot system comprising:
an obtaining unit configured to obtain a process definition for defining a procedure of the robot system to process a first workpiece into a second workpiece;
a determining unit configured to determine from the obtained process definition a parameter for controlling a feature of a motion path of the robot system, the motion path being used for processing the first workpiece into the second workpiece; and
a generating unit configured to generate a robot program for controlling the motion path based on the obtained process definition and the determined parameter, the robot program comprising a variable for adjusting the parameter;
the robot system; and
an apparatus for controlling the robot system comprising:
an importing unit configured to import a robot program for controlling a motion path of the robot system, the motion path being used for processing a first workpiece into a second workpiece, and the robot program comprising a variable for representing a parameter for controlling a feature of the motion path;
a providing unit configured to provide an interface for controlling the robot system; and
an updating unit configured to, in response to receiving an input from the interface for adjusting the parameter, update the robot program based on the input.
